(19) United States
(12) Patent Application Publication
(10) Pub. No.: US 2006/0288552 A1
(43) Pub. Date: Dec. 28, 2006

(54) Quick Connector Disposable Tool

(76) Inventors: Jessica L. Roll, Minnetonka, MN (US); Kelly A. Dockendorf, St. Paul, MN (US); Jonathan J. Lund, Minneapolis, MN (US)

Correspondence Address: AMS RESEARCH CORPORATION, 10700 BREN ROAD WEST, MINNETONKA, MN, 55343, US

(21) Appl. No.: 11/462,598

(22) Filed: Aug. 4, 2006

Related U.S. Application Data
(63) Continuation-in-part of application No. 11/276,723, filed on Mar. 10, 2006.
(60) Provisional application No. 60/660,491, filed on Mar. 10, 2005.
(60) Provisional application No. 60/705,657, filed on Aug. 4, 2005.

(51) Int. Cl. B23P 19/04

(52) U.S. Cl. 29/237

(57) ABSTRACT

Several embodiments of a disposable surgical tool for quickly and easily connecting tubing to implantable components are disclosed. A method for using the novel tool for connecting tubing to components, such as a pump, a reservoir, a connector, etc., is also described.

### CROSS-REFERENCE To RELATED APPLICATION

This application is a continuation-in-part of U.S. utility patent application Ser. No. 11/276,723, filed Mar. 10, 2006, which claims priority of U.S. provisional patent application No. 60/660,491, filed Mar. 10, 2005. This application additionally claims the benefit of provisional patent application No. 60/705,657 filed Aug. 4, 2005. Each of the previously noted applications are hereby incorporated by reference.

### TECHNICAL FIELD

The present invention relates to surgical tools and methods. More specifically, the present invention pertains to disposable tools and methods for connecting tubing to components.

### BACKGROUND

Certain surgical procedures, such as a penile implant, include the placement of a system of interconnected components within a body. Components in such systems may include a cylinder, reservoir, pump, etc. Some such components, such as a balloon, may be configured for selective inflation and/or deflation by an operator. Typically, a system may include an inflatable/deflatable component interconnected to a fluid-filled reservoir, a pump, and a valve assembly. During use, the pump may be actuated and fluid transferred from the reservoir into the component, causing the component to inflate. Later, a valve assembly may be operated deflating the component by transferring the fluid from the inflated component back into the reservoir.

An implantable system may include a multitude of tubing interconnecting several components. Typically, the tubing may be inserted into a strain relief component and the open end of the tubing connected to the component. In known examples, such as U.S. Pat. No. 4,651,721 to Mikulich et al. and U.S. Pat. No. 5,167,611 to Cowan, among others, a straight bore is extended through a strain relief and into the inflatable/deflatable component.

The points of connection between the tubing and the components may be a source of complication, such as leakage, disconnect, etc., and may also pose sterilization challenges in certain environments. Additionally, portability and handling of the connection tools for effecting the connections may also pose a challenge due to the weight and size of the connection tool.

Accordingly, there exists a need in the art for connection tools and methods which facilitate such surgical procedures.

### SUMMARY

In one aspect, the present invention discloses a surgical tool and method for connecting tubing to components, such as a pump, a reservoir, a connector, etc.

While multiple embodiments of the instant invention are disclosed, still other embodiments may become apparent to those skilled in the art. The following detailed description shows and describes illustrative embodiments of the present invention. As will be realized, the embodiment are capable of modifications in various aspects, all without departing from the spirit and scope of the instant invention. Accordingly, the drawings and detailed description are to be regarded as illustrative in nature and not restrictive.

### BRIEF DESCRIPTION OF THE DRAWINGS

FIG. 1 illustrates a prior art tool for connecting tubing to a component;

FIGS. 2A-2C illustrate a method of using the tool of FIG. 1;

FIG. 3 illustrates one embodiment of a tool of the present invention; and

FIGS. 4A and 4B show alternate views of an embodiment of a jaw section of a tool of the present invention.

### DETAILED DESCRIPTION

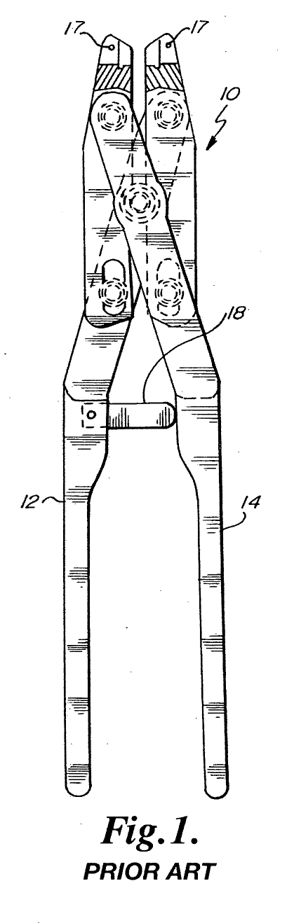

FIG. 1 illustrates a prior art tool 10 for connecting tubing to a component. As shown, tool 10 includes two arms or handles 12 and 14, tubing connecting section 16 including jaws 17, and stop member 18 to prevent connecting section 16 from closing all the way or to close only up to a predetermined position.

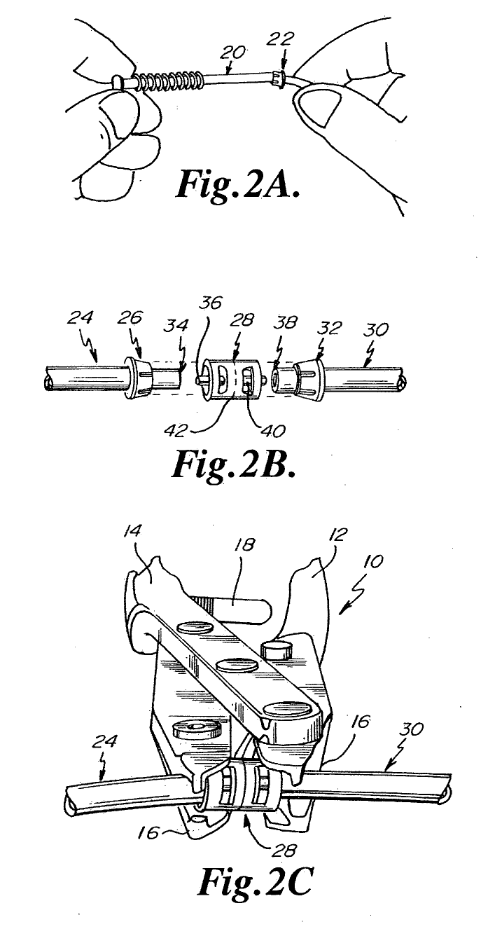

FIGS. 2A-2C illustrate a method for connecting two tubing segments or tubes to each other using a prior art tool, such as tool 10. The first step of the method is to place a collet over the tubing, such as sliding collet 22 onto tubing 20 as shown in FIG. 2A. FIG. 2B shows tubing connector 28 for connecting tubing segments 24 and 30 to each other at their respective open ends 34 and 38. Tubing connector 28 is shown having ports 36 and 40 through which tubing 24 and 30, respectively, will be connected. Tubing 24 includes collet 26 proximate open end 34, and tubing 30 includes collet 32 proximate open end 38. Next, open end 34 is slid over port 36 until open end 34 touches wall 42 in connector 28. Similarly, open end 38 of tubing 30 is pushed over port 40 until open end 38 also touches wall 42. Then collet 26 and 32 are slid over tubing 24 and 30 towards the edges of connector 28. Jaws 17 of tubing connecting section 16 are placed around collet 26 and 32, as illustrated in FIG. 2C, and handles 12 and 14 of tool 10 are squeezed together until closure stop 18 on handle 14 touches opposite handle 12. Thus tubing 24 and 30 are connected and tool 10 removed.

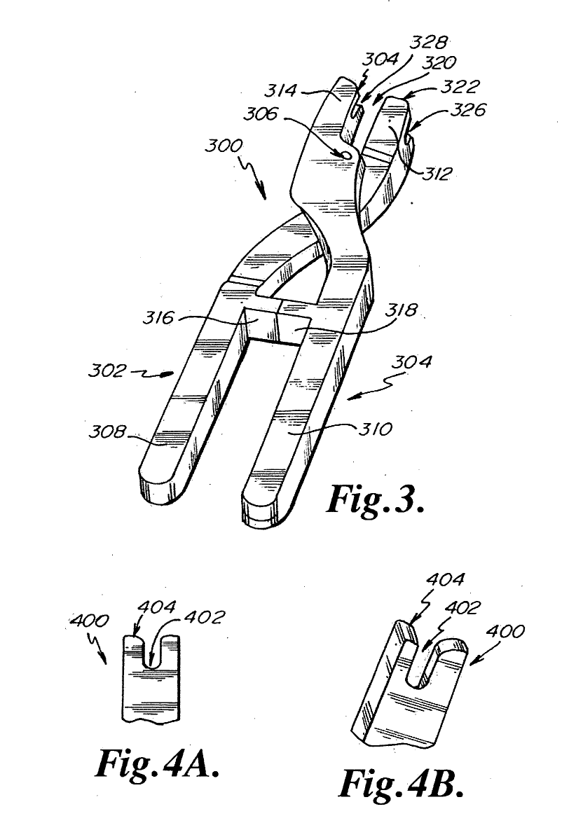

Alternate embodiments of a tool for connecting tubing to components or tubing connectors such as connector 28 are illustrated in FIGS. 3A-3C.

FIG. 3 illustrates tool 300 in accordance with an embodiment of the present invention. Tool 300 may include first and second cooperatively operable elongate members 302 and 304 pivotally interconnected at pivot point 306. Each first and second elongate members 302 and 304 may respectively include handle sections 308 and 310, jaw sections 312 and 314, and inwardly extending projections 316 and 318.

In one embodiment, inwardly extending projections 316 and 318 may be at approximately the same distance from pivot point 306. In an alternate embodiment, inwardly extending projections 316 and 318 may be at different distances from pivot point 306. In another embodiment, inwardly extending projections 316 and 318 may be orthogonal relative to their respective elongate members 302 and 304. In yet another embodiment, inwardly extending projections 316 and 318 may extend the same distance from an inside surface of their respective elongate members 302 and 304. In an alternate embodiment, inwardly extending projections 316 and 318 may extend different distances from an inside surface of their respective elongate members 302 and 304.

When used in accordance with an embodiment of the present invention, inwardly extending projections 316 and 318 may function as one or more stop members preventing jaw sections 312 and 314 from closing all the way. In one embodiment of the present invention, minimum separation distance 320 between jaw sections 312 and 314 may be governed by the distance each inwardly extending projections 316 and 318 extends from their respective elongate members 302 and 304. In another embodiment of the present invention, minimum separation distance 320 between jaw sections 312 and 314 may be governed by the distance between pivot point 306 and each inwardly extending projections 316 and 318.

In an embodiment of the present invention, each jaw section 312 and 314 may respectively include a tip 322 and 324. In one such embodiment, each tip 322 and 324 may respectively include a recess 326 and 328. Recess 326 and 328 may span a depth from respective tip 322 and 324 into respective jaw section 312 and 314. The depth spanned by each recess 326 and 328 may at least equal an outside diameter of tubing 30. In one embodiment, each recess 326 and 328 may span a width of respective jaw section 312 and 314, extending from an inner surface to an outer surface of each jaw section 312 and 314. In another embodiment, each recess 326 and 328 may span a height of respective jaw section 312 and 314. The height spanned by each recess 326 and 328 may at least equal an outside diameter of tubing 30 but less than a diameter of a collet. In an alternate embodiment, recess 326 and 328 may be mirror-images of one another.

FIGS. 4A and 4B illustrate alternate views of an embodiment of jaw section 400 of tool 300. FIG. 4A is an illustrative side view of jaw section 400 when viewed from the outer surface of jaw section 400; and FIG. 4B is an illustrative perspective view of jaw section 400. An embodiment of jaw section 400 may include recess 402 spanning a depth from tip 404 into jaw section 400. The depth spanned by recess 402 may at least equal an outside diameter of tubing 30. In one embodiment, recess 402 may span a width of jaw section 400 extending from an outer surface to an inner surface of jaw section 400. In another embodiment, recess 402 may span a height of jaw section 400. The height spanned by each recess 402 may at least equal an outside diameter of tubing 30 but less than a diameter of a collet.

An embodiment of tool 300 of the present invention, such as that illustrated in FIGS. 3, 4A, and 4B, may be used for connecting two tubing segments or tubes to each other. In one embodiment of a method of using tool 300 for connecting two tubing segments or tubes to each other, the previously described method in reference to FIGS. 2A and 2B may be used for preparing an assembly. Then, the assembly of tubing connector 28 with collets 26 and 32 may be placed between jaw sections 312 and 314. Tubing 24 and 30 may be passed through recess 326 and 328 such that the entire outer surface of tubing 24 and 30 is placed within recess 326 and 328. Next, handle sections 308 and 310 of tool 300 may be squeezed together thereby decreasing the spacing between jaw sections 312 and 314, and forcing collets 26 and 32 into tubing connector 28. As such, tubing 24 and 30 may be fixedly attached to tubing connector 28 and to one another. Jaw sections 312 and 314 may be drawn apart and the tubing assembly removed from tool 300 by sliding tubing 24 and 30 out of recess 326 and 328 and past tips 322 and 24. As previously described, inwardly extending projections 316 and 318 in an embodiment of tool 300 may function as stop members such that minimum separation distance 320 between jaw sections 312 and 314 may not be less than a longitudinal length of tubing connector 28.

In one or more embodiments of the present invention, tool 300 may be disposable after use. In other embodiments, elongate members 302 and 304 of tool 300 may be formed by a molding process. In yet other embodiments, elongate members 302 and 304 of tool 300 may be molded from polymers including, but not limited to, nylon, polycarbonate, and delrin, among others. In one or more embodiments, tool 300 may be sterilizable. Alternatively, tool 300 may be sterilized after manufacture and packaged in a sterile container. In other embodiments, tool 300 may have an ergonomic design.

In one or more embodiments of the present invention, jaw sections 312 and 314 of tool 300 may be substantially parallel to one another when the distance between jaw sections 312 and 314 is approximately equal to minimum separation distance 320. In other embodiments, jaw sections 312 and 314 may travel towards one another in a substantially linear manner when the distance between jaw sections 312 and 314 is approximately equal to minimum separation distance 320.

Various modifications and additions may be made to the exemplary embodiments presented hereinabove without departing from the scope and intent of the present invention. For example, while the disclosed embodiments refer to particular features, the scope of the instant invention is considered to also include embodiments having different combinations of features that do not include all of the features described herein. Accordingly, the scope of the present invention is intended to embrace all such alternatives, modifications, and variations as falling within the scope and intent of the appended claims, including all equivalents thereof.

We claim:

1. A connecting tool, comprising:
a pair of cooperatively operable elongate members pivotally interconnected at a pivot point;
each elongate member having a handle section and a jaw section;
each of the handle sections having a projection proximate to the pivot point for limiting closure of the jaw sections to a minimum separation distance; and
wherein a tip of each jaw section comprises a recess therein.

2. The connecting tool of claim 1, wherein the recess in the tip of one jaw section is a mirror-image of the recess in the tip of the other jaw section.

3. The connecting tool of claim 1, wherein the recess spans a depth of the jaw section.

4. The connecting tool of claim 3, wherein the depth of the recess is at least equal to an outside diameter of a tubing.

5. The connecting tool of claim 3, wherein the recess spans a width and a height of each jaw section.

6. The connecting tool of claim 5, wherein the height of the recess is:
larger than the outside diameter of the tubing; and
smaller than a diameter of a collet.

7. The connecting tool of claim 1, wherein each of the jaw sections are substantially parallel to one another when the jaw sections are proximate the minimum separation distance.

8. The connecting tool of claim 1, wherein the jaw sections move in a substantial linear manner relative to one another when the jaw sections are proximate the minimum separation distance.

9. The connecting tool of claim 1, comprising disposable elongate members.

10. The connecting tool of claim 1, comprising elongate members formed from a molding process.

11. The connecting tool of claim 10, comprising elongate members molded from a polymer.

12. The connecting tool of claim 11, wherein the polymer is selected from a group consisting of nylon, polycarbonate, and delrin.

13. The connecting tool of claim 1, comprising sterilizable elongate members.

14. The connection tool of claim 1, comprising ergonomic elongate members.

15. A tool for connecting tubing to a component, the tool comprising means for fixedly attaching the tubing to at least one port on the component.

16. The tool of claim 15, comprising:
means for positioning a collet on the tubing; and
means for connecting the tubing to the at least one port on the component.

17. The tool of claim 16, further comprising means for forcing the collet onto the at least one port on the component.
